(19) United States
(12) Patent Application Publication
(10) Pub. No.: US 2026/0063571 A1
(43) Pub. Date: Mar. 5, 2026

(54) SUBSTRATE INSPECTION APPARATUS, SUBSTRATE PROCESSING SYSTEM INCLUDING THE SAME, AND SUBSTRATE INSPECTION METHOD USING THE SAME

(71) Applicant: SAMSUNG ELECTRONICS CO., LTD., Suwon-si (KR)

(72) Inventors: Minho Rim, Suwon-si (KR); Souk Kim, Suwon-si (KR); Younghoon Sohn, Suwon-si (KR)

(73) Assignee: SAMSUNG ELECTRONICS CO., LTD., Suwon-si (KR)

(21) Appl. No.: 19/056,090

(22) Filed: Feb. 18, 2025

(30) Foreign Application Priority Data
Aug. 27, 2024 (KR) 10-2024-0115401

(51) Int. Cl. G01N 21/95

(52) U.S. Cl. CPC G01N 21/9503

(57) ABSTRACT

A substrate inspection apparatus may include: a plurality of inspection units, each of the plurality of inspection units including a light generator and a detector; a support configured to support and rotate a substrate; and an analyzer connected to the detector of each of the plurality of inspection units and configured to analyze an input obtained from the detector, wherein, in a plan view, the substrate includes a center region and an edge region enclosing the center region, wherein the light generator of each of the plurality of inspection units is configured to emit light toward the edge region of the substrate, wherein the detector of each of the plurality of inspection units is configured to detect the light that is emitted towards the edge region of the substrate, and wherein each of the plurality of inspection units extends parallel to a top surface of the substrate.

### CROSS-REFERENCE TO RELATED APPLICATIONS

This U.S. non-provisional patent application claims priority under 35 U.S.C. § 119 to Korean Patent Application No. 10-2024-0115401, filed on Aug. 27, 2024, in the Korean Intellectual Property Office, the entire contents of which are hereby incorporated by reference.

### BACKGROUND

### 1. Field

Embodiments of the present disclosure relate to a substrate inspection apparatus, and in particular, to a substrate inspection apparatus configured to examine whether there is a failure on an edge region of a substrate.

### 2. Brief Description of Background Art

In a semiconductor fabrication process, a substrate is used as a key component in forming a semiconductor device. Since the performance of the fabricated semiconductor device relies on the quality of the substrate, it is very important to accurately inspect a defect on every region of the substrate including an edge region. Currently, optical inspection, laser scan inspection, and ultrasonic inspection methods are used to detect a defect on the edge region of the substrate. These methods each have their advantages, but there are limitations in detecting a defect on the edge region of the substrate perfectly. Thus, there is a demand for technology capable of accurately and efficiently inspecting defects on the edge region of the substrate.

### SUMMARY

According to an embodiment of the present disclosure, a substrate inspection apparatus may be provided and configured to inspect a defect on the edge region of the substrate using an optical diffraction pattern.

According to an embodiment of the present disclosure, a substrate inspection method of inspecting a defect on the edge region of the substrate using an optical diffraction pattern may be provided.

According to an embodiment of the present disclosure, a substrate processing system may be provided and configured to inspect a defect on the edge region of the substrate using an optical diffraction pattern.

According to an embodiment of the present disclosure, a substrate inspection apparatus may include: a plurality of inspection units, each of the plurality of inspection units including a light generator and a detector; a support configured to support and rotate a substrate; and an analyzer connected to the detector of each of the plurality of inspection units and configured to analyze an input obtained from the detector, wherein, in a plan view, the substrate includes a center region and an edge region enclosing the center region, wherein the light generator of each of the plurality of inspection units is configured to emit light toward the edge region of the substrate, wherein the detector of each of the plurality of inspection units is configured to detect the light that is emitted towards the edge region of the substrate, and wherein each of the plurality of inspection units extends parallel to a top surface of the substrate.

According to an embodiment of the present disclosure, a substrate inspection method may include: preparing a substrate including a center region and an edge region enclosing the center region; emitting at least one light toward the edge region of the substrate; detecting at least one diffraction pattern based on the at least one light that is emitted toward the edge region of the substrate; and analyzing the at least one diffraction pattern that is detected, wherein the emitting the at least one light includes generating at least one diffraction light, and wherein the at least one diffraction pattern is produced by the at least one diffraction light.

According to an embodiment of the present disclosure, a substrate processing system may include: an interface module including an aligner that is configured to align a substrate; and a substrate processor connected to the interface module, wherein the substrate includes a center region and an edge region enclosing the center region, wherein the aligner includes: a support configured to rotate the substrate; an alignment detector configured to detect a notch of the substrate; and a substrate inspector configured to inspect the edge region of the substrate, and wherein the substrate inspector is configured to detect a defect on the edge region based on at least one diffraction pattern.

### BRIEF DESCRIPTION OF DRAWINGS

FIG. 1 is a plan view illustrating a substrate inspection apparatus according to an embodiment of the present disclosure.

FIG. 2 is a side view illustrating a substrate inspection apparatus according to an embodiment of the present disclosure.

FIG. 3 is an enlarged plan view illustrating a portion X of FIG. 1.

FIG. 4 is a plan view illustrating a substrate inspection apparatus according to an embodiment of the present disclosure.

FIG. 5 is a plan view illustrating a substrate inspection apparatus according to an embodiment of the present disclosure.

FIG. 6 is a plan view illustrating a substrate inspection apparatus according to an embodiment of the present disclosure.

FIG. 7 is a plan view illustrating a substrate processing system according to an embodiment of the present disclosure.

FIG. 8 is a perspective view illustrating a aligner according to an embodiment of the present disclosure.

FIG. 9 is a flow chart illustrating a substrate inspection method according to an embodiment of the present disclosure.

FIGS. 10 to 14 are diagrams illustrating a substrate inspection method according to an embodiment of the present disclosure.

### DETAILED DESCRIPTION

Non-limiting example embodiments of the present disclosures will now be described more fully with reference to the accompanying drawings, in which non-limiting example embodiments are shown. Like reference numerals in the drawings denote like elements, and thus repeated descriptions thereof may be omitted.

It will be understood that when an element or layer is referred to as being “on,” “connected to,” or “coupled to” another element or layer, it can be directly on, connected to, or coupled to the other element or layer or intervening elements or layers may be present. In contrast, when an element or layer is referred to as being “directly on,” “directly connected to,” or “directly coupled to” another element or layer, there are no intervening elements or layers present.

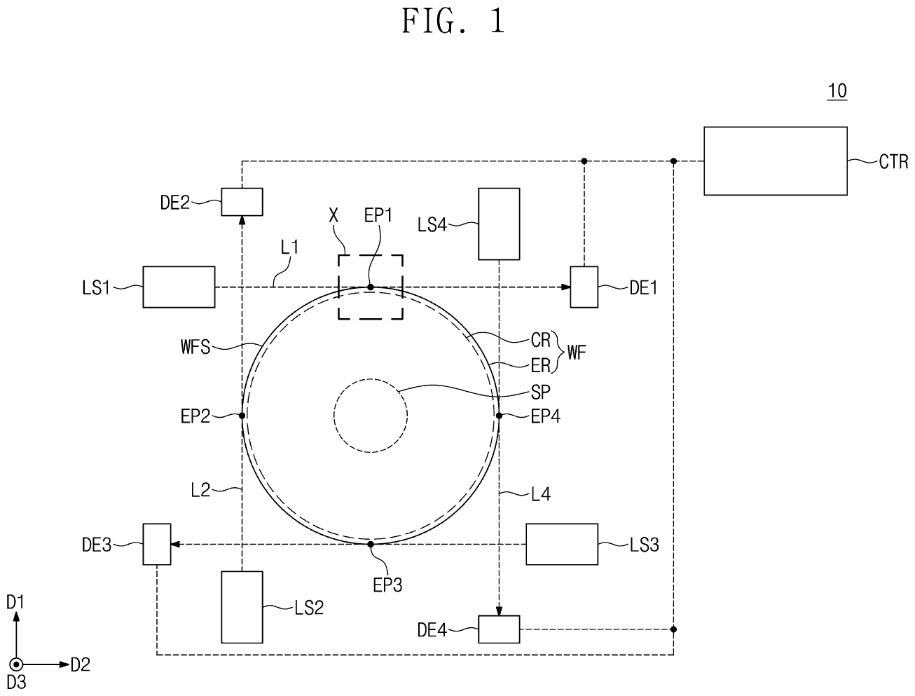

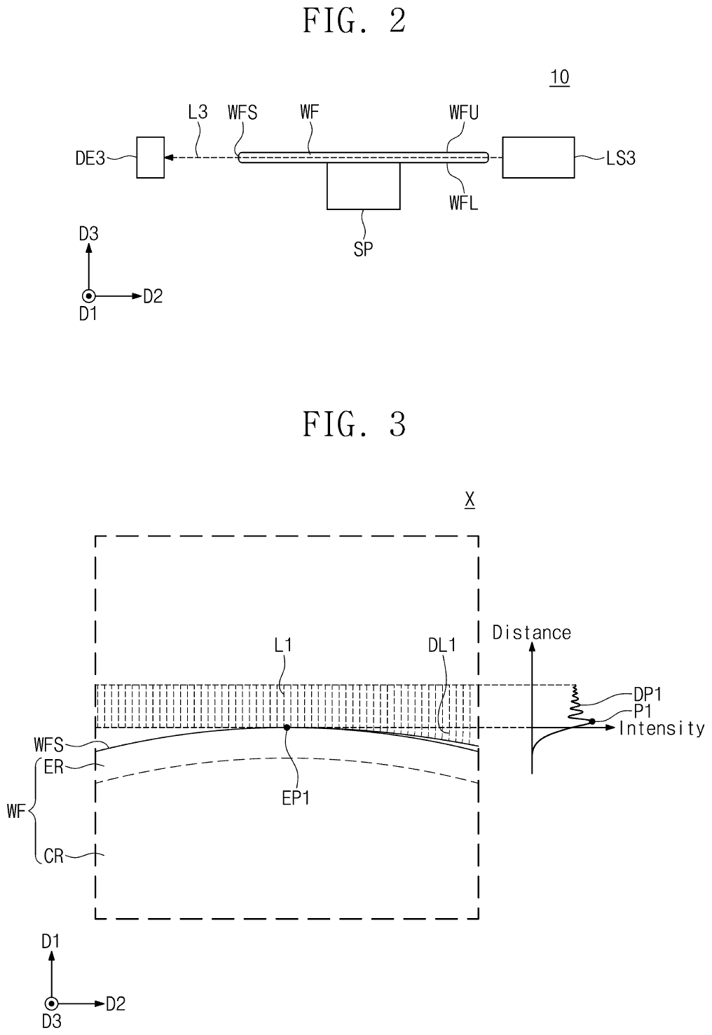

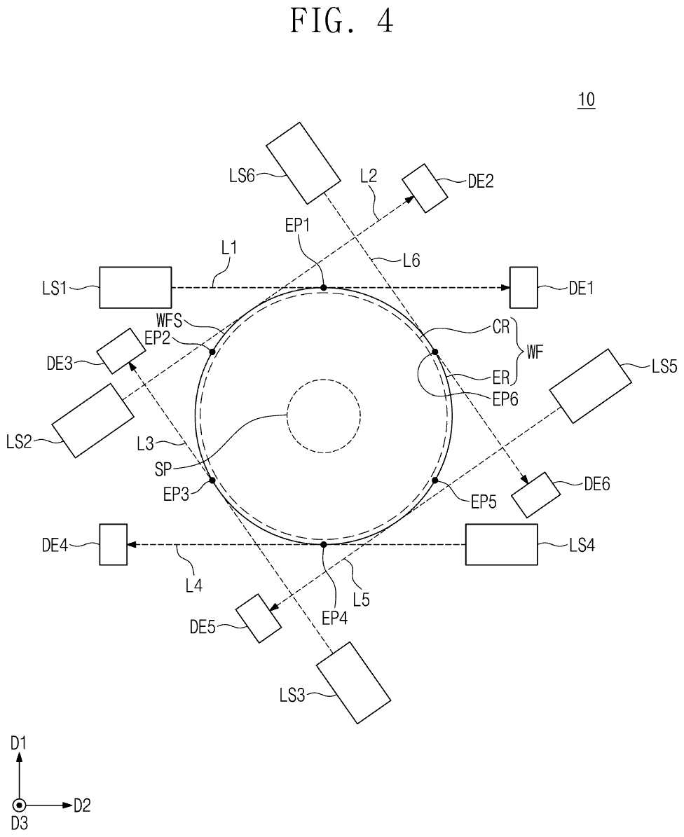

FIG. 1 is a plan view illustrating a substrate inspection apparatus according to an embodiment of the present disclosure. FIG. 2 is a side view illustrating a substrate inspection apparatus according to an embodiment of the present disclosure. FIG. 3 is an enlarged plan view illustrating a portion X of FIG. 1. FIG. 4 is a plan view illustrating a substrate inspection apparatus according to an embodiment of the present disclosure.

Referring to FIGS. 1 and 2, a substrate inspection apparatus 10 may be provided. The substrate inspection apparatus 10 may be configured to inspect a portion of a substrate WF. For example, the substrate WF may include a center region CR and an edge region ER enclosing the center region CR, when viewed in a plan view, and the substrate inspection apparatus 10 may be configured to perform an inspection process on the edge region ER of the substrate WF. In the present specification, the term of “the substrate WF” may be used to refer to a silicon wafer, but embodiments of the present disclosure are not limited to this example. The substrate inspection apparatus 10 may include a supporting portion SP (e.g., supporter), a plurality of inspection units, and an analyzing unit CTR (e.g., an analyzer).

The supporting portion SP of the substrate inspection apparatus 10 may be configured to support the substrate WF. The substrate WF may be disposed on the supporting portion SP (e.g., supporter) in such a way that a top surface WFU of the substrate WF is parallel to a first direction D1 and a second direction D2. A top surface of the supporting portion SP may be in contact with a bottom surface WFL of the substrate WF. For example, the supporting portion SP may be configured to hold and support the substrate WF on the top surface thereof using a vacuum pressure. For this, the supporting portion SP may include a porous structure, which is exposed through the top surface thereof, but embodiments of the present disclosure are not limited to this example. The supporting portion SP may include a motor and may be configured to rotate in a clockwise or counter-clockwise direction. Thus, the substrate WF may also rotate with the supporting portion SP. In other words, the supporting portion SP may be used to rotate the substrate WF in the clockwise or counter-clockwise direction.

In the present specification, the first direction D1 and the second direction D2 may not be parallel to each other. A third direction D3 may not be parallel to the first direction D1 and the second direction D2. In an embodiment, the first direction D1, the second direction D2, and the third direction D3 may be orthogonal to each other. For example, the first direction D1 and the second direction D2 may be horizontal directions, and the third direction D3 may be a vertical direction.

First to fourth light generating portions LS1, LS2, LS3, and LS4 (e.g., first to fourth light generators) may be provided. The first to fourth light generating portions LS1, LS2, LS3, and LS4 may be disposed adjacent to the supporting portion SP and the substrate WF. The first to fourth light generating portions LS1, LS2, LS3, and LS4 may be spaced apart from each other and may be two-dimensionally arranged. For example, the first to fourth light generating portions LS1, LS2, LS3, and LS4 may be placed at the four vertices of a rectangle centered on the substrate WF.

Each of the first to fourth light generating portions LS1, LS2, LS3, and LS4 may be configured to emit light. The first light generating portion LS1 may be configured to emit a first light L1, the second light generating portion LS2 may be configured to emit a second light L2, the third light generating portion LS3 may be configured to emit a third light L3, and the fourth light generating portion LS4 may be configured to emit a fourth light L4. More specifically, the first to fourth light generating portions LS1, LS2, LS3, and LS4 may be configured to emit the first to fourth lights L1, L2, L3, and L4, respectively, toward the edge region ER of the substrate WF. For example, each of the first to fourth light generating portions LS1, LS2, LS3, and LS4 may be a laser device that generates light at a single wavelength.

Each of the first to fourth lights L1, L2, L3, and L4 may be parallel to the top surface WFU of the substrate WF. Each of the first to fourth lights L1, L2, L3, and L4 may be parallel to a tangential direction of the substrate WF. Each of the first to fourth lights L1, L2, L3, and L4 may pass by a side surface WFS of the substrate WF. The first light L1 and the third light L3 may be parallel to the second direction D2, and the second light L2 and the fourth light L4 may be parallel to the first direction D1, but embodiments of the present disclosure are not limited to this example. For example, the first light L1 may pass by a first edge point EP1 that is in contact with the side surface WFS of the substrate WF. The second light L2 may pass by a second edge point EP2 that is in contact with the side surface WFS of the substrate WF. The third light L3 may pass by a third edge point EP3 that is in contact with the side surface WFS of the substrate WF. The fourth light L4 may pass by a fourth edge point EP4 that is in contact with the side surface WFS of the substrate WF.

In an embodiment, the first to fourth lights L1, L2, L3, and L4 may have different wavelengths from each other. For example, the wavelength of the first light L1 may be in a range from about 400 nm to about 450 nm. The wavelength of the second light L2 may be in a range from about 500 nm to about 550 nm. The wavelength of the third light L3 may be in a range from about 600 nm to about 650 nm. The wavelength of the fourth light L4 may be in a range from about 800 nm to about 850 nm.

Referring to FIG. 3, the first light L1 may propagate in the tangential direction of the substrate WF and may pass by the side surface WFS of the substrate WF at the first edge point EP1. More specifically, the first light L1 may pass by the side surface WFS of the substrate WF, and a portion of the top surface WFU and the bottom surface WFL of the substrate WF corresponding to the edge region ER. In this case, a first diffraction light DL1 may be generated. The first light L1 may propagate as a plane wave, and the first diffraction light DL1 may propagate as a spherical wave. The first diffraction light DL1 may exhibit a first diffraction pattern DP1. In an embodiment, the first diffraction light DL1 may be generated by a curved edge diffraction (CED), and the first diffraction pattern DP1 may be a Fresnel pattern.

The first diffraction pattern DP1 may have a first peak P1 at which the intensity of the light is the highest. The intensity of the first peak P1 of the first diffraction pattern DP1 may be based on the state of the edge region ER of the substrate WF at the first edge point EP1. For example, if there is a defect issue (e.g., a contamination particle and/or a crack) on the edge region ER of the substrate WF at the first edge point EP1, the first peak P1 of the first diffraction pattern DP1 may be increased or decreased. By analyzing the variation of the first peak P1 of the first diffraction pattern DP1, it may be possible to examine whether there is a defect on the edge region ER of the substrate WF.

Similarly, the second light L2 may generate a second diffraction light as it passes by the side surface WFS of the substrate WF at the second edge point EP2, the third light L3 may generate a third diffraction light as it passes by the side surface WFS of the substrate WF at the third edge point EP3, and the fourth light L4 may generate a fourth diffraction light as it passes by the side surface WFS of the substrate WF at the fourth edge point EP4. The second to fourth diffraction lights may exhibit diffraction patterns, respectively, which are different from the first diffraction pattern DP1.

In other words, the diffraction pattern of the first light L1 on the edge region ER of the substrate WF may be obtained at the first edge point EP1. Similarly, the diffraction pattern of the second light L2 may be obtained at the second edge point EP2, the diffraction pattern of the third light L3 may be obtained at the third edge point EP3, and the diffraction pattern of the fourth light L4 may be obtained at the fourth edge point EP4. Since the substrate WF rotates, the entire edge region ER of the substrate WF may pass by the first to fourth edge points EP1, EP2, EP3, and EP4. Accordingly, the entire edge region ER of the substrate WF may be inspected.

The magnitude of the peak of the diffraction pattern at a specific wavelength may be very sensitive to the type of defect. Since the first to fourth lights L1, L2, L3, and L4 have different wavelengths, it may be possible to easily detect various types of defects. Thus, the inspection accuracy of the substrate inspection apparatus 10 may be improved.

Referring back to FIGS. 1 and 2, first to fourth detection portions DE1, DE2, DE3, and DE4 (e.g., first to fourth detectors) may be provided. Each of the first to fourth detection portions DE1, DE2, DE3, and DE4 may be configured to sense light and convert the light to an electrical signal. For example, the first detection portion DE1 may be configured to sense the first light L1 emitted from the first light generating portion LS1, the second detection portion DE2 may be configured to sense the second light L2 emitted from the second light generating portion LS2, the third detection portion DE3 may be configured to sense the third light L3 emitted from the third light generating portion LS3, and the fourth detection portion DE4 may be configured to sense the fourth light L4 emitted from the fourth light generating portion LS4. For this, each of the first to fourth detection portions DE1, DE2, DE3, and DE4 may be disposed to face a corresponding one of the first to fourth light generating portions LS1, LS2, LS3, and LS4. Similar to the first to fourth light generating portions LS1, LS2, LS3, and LS4, the first to fourth detection portions DE1, DE2, DE3, and DE4 may be disposed adjacent to the supporting portion SP and the substrate WF and may be two-dimensionally arranged.

One of the first to fourth light generating portions LS1, LS2, LS3, and LS4 and a corresponding one of the first to fourth detection portions DE1, DE2, DE3, and DE4 may constitute one inspection unit. For example, the first light generating portion LS1 and the first detection portion DE1 may constitute a first inspection unit. The second light generating portion LS2 and the second detection portion DE2 may constitute a second inspection unit. The third light generating portion LS3 and the third detection portion DE3 may constitute a third inspection unit. The fourth light generating portion LS4 and the fourth detection portion DE4 may constitute a fourth inspection unit. That is, the substrate inspection apparatus 10 may include the first to fourth inspection units. Since the first to fourth lights L1, L2, L3, and L4 are emitted to be parallel to the top surface WFU of the substrate WF, the first to fourth inspection units may also extend parallel to the top surface WFU of the substrate WF and may be placed at substantially the same level as the substrate WF.

The analyzing unit CTR may be connected to the first to fourth detection portions DE1, DE2, DE3, and DE4. The analyzing unit CTR may receive electrical signals from the first to fourth detection portions DE1, DE2, DE3, and DE4. The analyzing unit CTR may be configured to analyze the electrical signals, generate information on the first to fourth lights L1, L2, L3, and L4, and display the information on a user screen.

Referring to FIG. 4, the substrate inspection apparatus 10 may further include a fifth light generating portion LS5 emitting a fifth light L5, a fifth detection portion DE5 sensing the fifth light L5, a sixth light generating portion LS6 emitting a sixth light L6, and a sixth detection portion DE6 sensing the sixth light L6. Here, the fifth light generating portion LS5 and the fifth detection portion DE5 may constitute a fifth inspection unit, and the sixth light generating portion LS6 and the sixth detection portion DE6 may constitute a sixth inspection unit. In other words, the substrate inspection apparatus 10 may further include the fifth and sixth inspection units. However, embodiments of the present disclosure are not limited to this example, and the substrate inspection apparatus 10 may be configured to include three or less inspection units or include seven or more inspection units.

The first to sixth light generating portions LS1, LS2, LS3, LS4, LS5, and LS6 may be two-dimensionally arranged around the substrate WF. Unlike the configuration shown in FIG. 1, the first to sixth light generating portions LS1, LS2, LS3, LS4, LS5, and LS6 may be placed at the six vertices of a hexagon centered on the substrate WF. Similar to the first to fourth detection portions DE1, DE2, DE3, and DE4, the fifth detection portion DE5 may be disposed to face the fifth light generating portion LS5, and the sixth detection portion DE6 may be disposed to face the sixth light generating portion LS6.

The fifth light L5 emitted from the fifth light generating portion LS5 may have a different wavelength from the sixth light L6 emitted from the sixth light generating portion LS6. In addition, the fifth light L5 and the sixth light L6 may have different wavelengths from the first to fourth lights L1, L2, L3, and L4. For example, each of the fifth light L5 and the sixth light L6 may have a wavelength that is longer or shorter than the first to fourth lights L1, L2, L3, and L4.

The fifth light L5 and the sixth light L6 may pass by the side surface WFS of the substrate WF, similar to the first to fourth lights L1, L2, L3, and L4. For example, the fifth light L5 may pass by the side surface WFS of the substrate WF at a fifth edge point EP5. The sixth light L6 may pass by the side surface WFS of the substrate WF at a sixth edge point EP6. As described with reference to FIG. 3, diffraction lights may be generated at the fifth edge point EP5 and the sixth edge point EP6. Thus, diffraction patterns may occur. Since the first to sixth lights L1, L2, L3, L4, L5, and L6 have different wavelengths from each other, it may be possible to easily detect various types of defects. Thus, the inspection accuracy of the substrate inspection apparatus 10 may be improved.

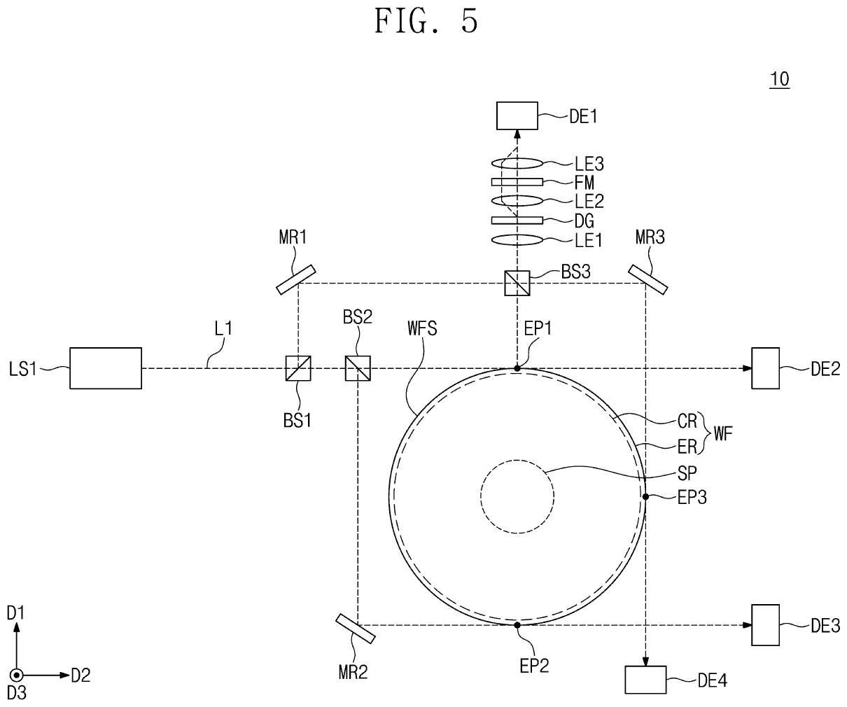

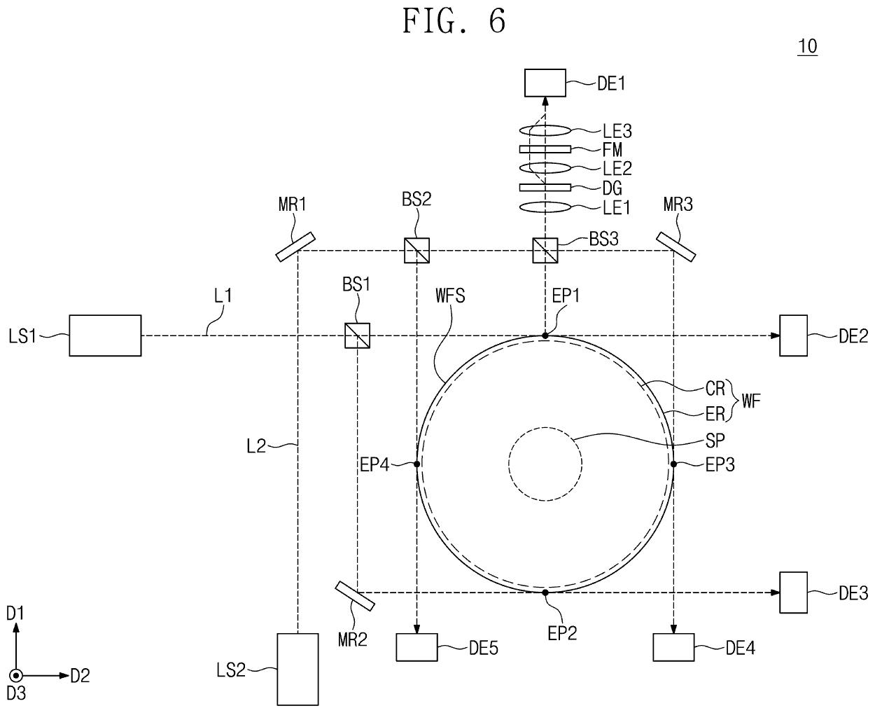

FIG. 5 is a plan view illustrating a substrate inspection apparatus according to an embodiment of the present disclosure. FIG. 6 is a plan view illustrating a substrate inspection apparatus according to an embodiment of the present disclosure.

Referring to FIG. 5, a substrate inspection apparatus 10 may be provided. For example, the substrate inspection apparatus 10 may be configured to inspect the edge region ER of the substrate WF. The substrate inspection apparatus 10 may include a supporting portion SP, a first light generating portion LS1, first to fourth detection portions DE1, DE2, DE3, and DE4, first to third beam splitters BS1, BS2, and BS3, and first to third mirrors MR1, MR2, and MR3. The supporting portion SP and the first light generating portion LS1 may be configured to have substantially the same features as those in the embodiment shown in FIGS. 1 and 2.

The first light generating portion LS1 may be configured to emit the first light L1 toward the side surface WFS of the substrate WF. For example, the first light generating portion LS1 may emit the first light L1 in the tangential direction (e.g., along a virtual tangential line) of the substrate WF. The first light L1 emitted from the first light generating portion LS1 may be incident into the first beam splitter BS1. For example, the first beam splitter BS1 may have a cube-shaped optical part, which is formed by attaching two prisms having a right triangular section. The first beam splitter BS1 may have a reflection layer therein. The first light L1 may pass through or be reflected by the reflection layer of the first beam splitter BS1. At least a portion of the first light L1, which passes through the reflection layer of the first beam splitter BS1, may be incident into the second beam splitter BS2. At least a portion of the first light L1, which is reflected by the reflection layer of the first beam splitter BS1, may be reflected by the first mirror MR1 and may be incident into the third beam splitter BS3.

The second beam splitter BS2 may have substantially the same structure as the first beam splitter BS1. For example, the first light L1 incident into the second beam splitter BS2 may pass through or be reflected by the reflection layer of the second beam splitter BS2. At least a portion of the first light L1, which passes through the reflection layer of the second beam splitter BS2, may pass by the first edge point EP1 of the substrate WF and may be incident into the second detection portion DE2. At least a portion of the first light L1, which is reflected by the reflection layer of the second beam splitter BS2, may be reflected by the second mirror MR2, may pass by the second edge point EP2, and may be incident into the third detection portion DE3.

The third beam splitter BS3 may have substantially the same structure as the first beam splitter BS1 and the second beam splitter BS2, and thus, at least a portion of the first light L1 incident into the third beam splitter BS3 may pass through or be reflected by the reflection layer of the third beam splitter BS3. At least a portion of the first light L1, which passes through the reflection layer of the third beam splitter BS3, may be reflected by the third mirror MR3, may pass by the third edge point EP3, and may be incident into the fourth detection portion DE4. At least a portion of the first light L1, which is reflected by the reflection layer of the third beam splitter BS3, may be reflected by the side surface WFS of the substrate WF at the first edge point EP1 and may be incident into the first detection portion DE1.

If the first light L1 passes by the side surface WFS (or the edge region ER) of the substrate WF at the first to third edge points EP1, EP2, and EP3, the first light L1 may form a diffraction pattern, due to the curved edge diffraction (CED), as described with reference to FIG. 3. That is, a plurality of diffraction patterns may be generated by the first light L1 passing by the first to third edge points EP1, EP2, and EP3. In this case, even when the substrate WF is partially rotated, the diffraction patterns may be obtained for the entire edge region ER of the substrate WF. Thus, the productivity of the substrate inspection apparatus 10 may be improved.

In an embodiment, first to third lenses LE1, LE2, and LE3, a diffraction grating DG, and a mask FM may be provided between the third beam splitter BS3 and the first detection portion DE1. The diffraction grating DG may be placed between the first lens LE1 and the second lens LE2. The diffraction grating DG may have various slit structures, and the first light L1 passing through the diffraction grating DG may be diffracted at various angles. The mask FM may be placed between the second lens LE2 and the third lens LE3. The mask FM may be configured to selectively transmit the first light L1 diffracted by the diffraction grating DG. For example, the first to third lenses LE1, LE2, and LE3, the diffraction grating DG, the mask FM, and the first detection portion DE1 may constitute a diffraction phase microscope (DPM).

Referring to FIG. 6, the substrate inspection apparatus 10 may further include the second light generating portion LS2 and the fifth detection portion DE5. The second light generating portion LS2 may emit the second light L2 in the tangential direction (e.g., along a virtual tangential line) of the substrate WF. For example, the wavelength of the second light L2 may be different from the wavelength of the first light L1.

The first light L1 emitted from the first light generating portion LS1 may be incident into the first beam splitter BS1 and may pass through or be reflected by the reflection layer of the first beam splitter BS1. At least a portion of the first light L1, which passes through the reflection layer of the first beam splitter BS1, may pass by the first edge point EP1 and may be incident into the second detection portion DE2. at least a portion of the first light L1, which is reflected by the reflection layer of the first beam splitter BS1, may be reflected by the second mirror MR2, may pass by the second edge point EP2, and may be incident into the third detection portion DE3.

The second light L2 emitted from the second light generating portion LS2 may be reflected by the first mirror MR1 and may be incident into the second beam splitter BS2. At least a portion of the second light L2, which passes through the reflection layer of the second beam splitter BS2, may be reflected by the third mirror MR3, may pass by the third edge point EP3, and may be incident into the fourth detection portion DE4. At least a portion of the second light L2, which is reflected by the reflection layer of the second beam splitter BS2, may pass by the fourth edge point EP4 and may be incident into the fifth detection portion DE5.

In addition, at least a portion of the second light L2, which passes through the reflection layer of the second beam splitter BS2, may be incident into the third beam splitter BS3, which is provided between the second beam splitter BS2 and the third mirror MR3, and may pass through or be reflected by the third beam splitter BS3. At least a portion of the second light L2, which is reflected by the reflection layer of the third beam splitter BS3, may be reflected by the side surface WFS of the substrate WF at the first edge point EP1 and may be incident into the first detection portion DE1.

If the first light L1 passes by the side surface WFS (or the edge region ER) of the substrate WF at the first edge point EP1 and the second edge point EP2 and the second light L2 passes by the side surface WFS (or the edge region ER) of the substrate WF at the third edge point EP3 and the fourth edge point EP4, the first light L1 and the second light L2 may generate diffraction patterns, due to the curved edge diffraction (CED), as described with reference to FIG. 3. That is, a plurality of diffraction patterns may be generated by the first and second lights L1 and L2 passing by the first to fourth edge points EP1, EP2, EP3, and EP4. In this case, even when the substrate WF is partially rotated, the diffraction patterns of the first light L1 and the second light L2 may be obtained for an entirety of the edge region ER of the substrate WF, and thus, the productivity and accuracy of the substrate inspection apparatus 10 may be improved.

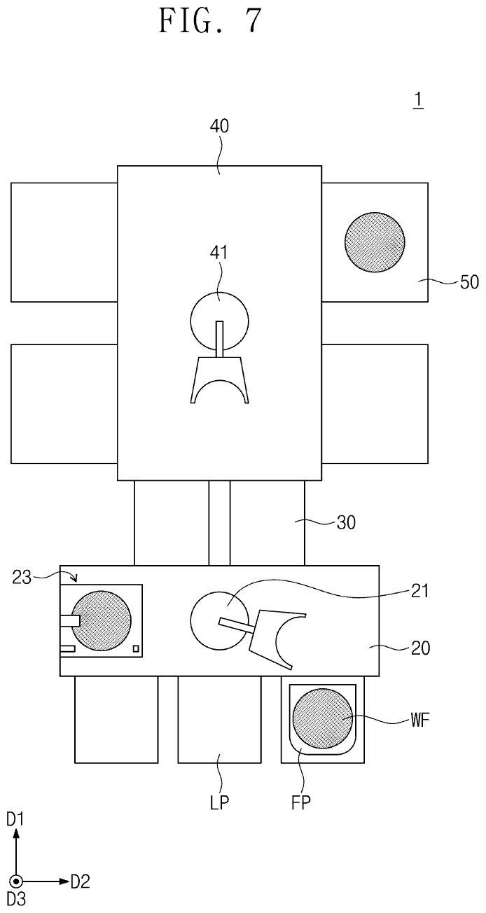

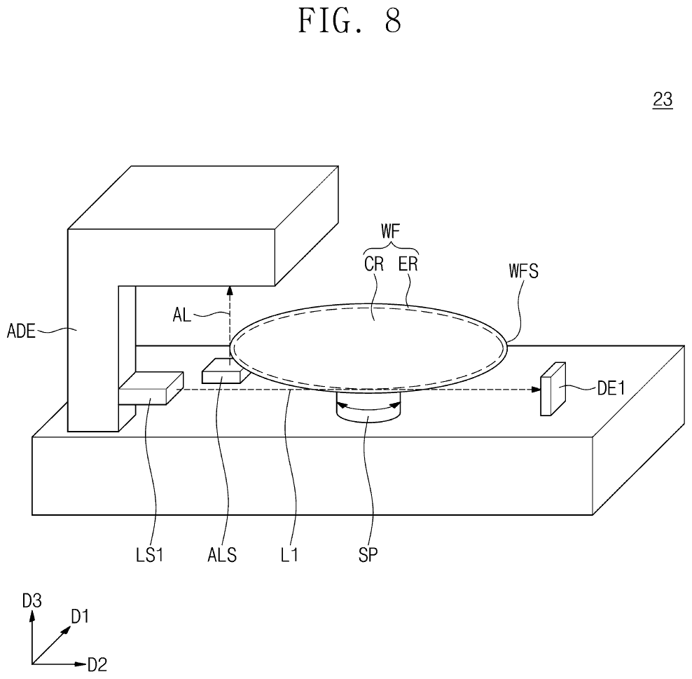

FIG. 7 is a plan view illustrating a substrate processing system according to an embodiment of the present disclosure. FIG. 8 is a perspective view illustrating an aligner according to an embodiment of the present disclosure.

Referring to FIG. 7, a substrate processing system 1 may be provided. For example, the substrate processing system 1 may be a single system composed of a plurality of apparatuses that are used to perform a semiconductor fabrication process on the substrate WF. The substrate processing system 1 may include a load port LP, an interface module 20 (e.g., an interface), a substrate loading unit 30 (e.g., a substrate loader), a substrate transfer unit 40 (e.g., a substrate transferor), and a substrate processing apparatus 50 (e.g., a substrate processor).

The load port LP may be configured to accommodate a front opening unified pod (FOUP) FP, in which the substrate WF is placed. If the FOUP FP is loaded on the load port LP, the load port LP may fasten the FOUP FP. The load port LP may dock the FOUP FP so that the FOUP FP and the interface module 20 are in contact with each other. The substrate WF in the FOUP FP may be loaded in or unloaded from the substrate processing system 1 through the load port LP. The number of the load port LP may be variously changed.

The interface module 20 may be placed between the load port LP and the substrate loading unit 30. The interface module 20 may be connected to the load port LP and the substrate loading unit 30. The load port LP and the substrate loading unit 30 may be spaced apart from each other with the interface module 20 interposed therebetween. The interface module 20 may include a first robot arm 21 and an aligner 23 provided therein. The first robot arm 21 of the interface module 20 may transfer the substrate WF in the FOUP FP to the substrate loading unit 30. In addition, the first robot arm 21 of the interface module 20 may transfer the substrate WF in the substrate loading unit 30 to the FOUP FP. The first robot arm 21 may place the substrate WF on the aligner 23, before transferring the substrate WF to the substrate loading unit 30 or the FOUP FP. The aligner 23 may be used to align the substrate WF in a specific direction. The aligner 23 will be described in more detail with reference to FIG. 8.

The substrate loading unit 30 may be placed between the interface module 20 and the substrate transfer unit 40. The substrate loading unit 30 may be connected to the interface module 20 and the substrate transfer unit 40. The interface module 20 and the substrate transfer unit 40 may be spaced apart from each other with the substrate loading unit 30 interposed therebetween. The substrate WF in the interface module 20 may be transferred to the substrate transfer unit 40 through the substrate loading unit 30. Alternatively, the substrate WF in the substrate transfer unit 40 may be transferred to the interface module 20 through the substrate loading unit 30. For example, the substrate loading unit 30 may be a load-lock chamber. In an embodiment, a plurality of substrate loading units 30 may be provided, but embodiments of the present disclosure are not limited to this example.

The substrate transfer unit 40 may be placed between the substrate processing apparatus 50 and the substrate loading unit 30. The substrate transfer unit 40 may be connected to the substrate processing apparatus 50 and the substrate loading unit 30. The substrate transfer unit 40 may include a second robot arm 41 provided therein. The second robot arm 41 of the substrate transfer unit 40 may transfer the substrate WF in the substrate loading unit 30 to the substrate processing apparatus 50. In addition, the second robot arm 41 of the substrate transfer unit 40 may transfer the substrate WF in the substrate processing apparatus 50 to the substrate loading unit 30. The substrate transfer unit 40 may be connected to a pump. An inner space of the substrate transfer unit 40 may be in a vacuum state by the pump. In an embodiment, one substrate transfer unit 40 may be connected to a plurality of substrate processing apparatuses 50, but embodiments of the present disclosure are not limited to this example. For example, the substrate transfer unit 40 may be a transfer module (TM) chamber.

The substrate processing apparatus 50 may be placed near the substrate transfer unit 40. The substrate processing apparatus 50 may be connected to the substrate transfer unit 40. The substrate processing apparatus 50 may be used to perform a semiconductor fabrication process. For example, the semiconductor fabrication process may include an exposure process, an etching process, a deposition process, a cleaning process, and an ion implantation process. In an embodiment, a plurality of substrate processing apparatuses 50 may be provided, but embodiments of the present disclosure are not limited to this example.

Referring to FIG. 8, the aligner 23 may include the supporting portion SP, an alignment light generating portion ALS (e.g., an alignment light generator), an alignment detection portion ADE (e.g., an alignment detector), the first light generating portion LS1, and the first detection portion DE1. The supporting portion SP may be configured to support and rotate the substrate WF and may have substantially the same features as the supporting portion SP of the embodiment shown in FIGS. 1 to 2.

The alignment light generating portion ALS may be placed near the substrate WF. The alignment light generating portion ALS may emit an alignment light AL in the third direction D3. The alignment light AL may pass through a portion of the side surface WFS of the substrate WF. The alignment detection portion ADE may receive the alignment light AL, which is emitted from the alignment light generating portion ALS. As the substrate WF is rotated, the intensity of the alignment light AL may vary depending on whether or not the alignment light AL passes through a notch of the substrate WF. By using such a variation of the intensity of the alignment light AL, the substrate WF may be aligned in such a way that the notch of the substrate WF is placed in a specific direction. In an embodiment, the alignment light generating portion ALS and the alignment detection portion ADE may constitute an aligning device (e.g., an alignment detector). Since the aligning device is placed above and below the substrate WF, the aligning device may not be located at the same level as the substrate WF.

The first light generating portion LS1 may be placed near the substrate WF and may be configured to emit the first light L1 in the second direction D2. The first light L1 may pass by a portion of the side surface WFS of the substrate WF and may be incident into the first detection portion DE1. As described with reference to FIG. 3, a diffraction light may be generated by the first light L1 passing by the side surface WFS of the substrate WF, and the diffraction pattern generated by the first light L1 may be obtained by the first detection portion DE1. Thus, if a defect is present on the edge region ER of the substrate WF, the defect may be detected. In other words, the inspection process on the edge region ER of the substrate WF may be performed during the alignment process on the substrate WF.

In an embodiment, the first light generating portion LS1 and the first detection portion DE1 may constitute a substrate inspection apparatus. The substrate inspection apparatus may be located at the same level as the substrate WF. The substrate inspection apparatus may include a plurality of light generating portions and a plurality of detection portions, as described with reference to FIGS. 1 to 4. The substrate inspection apparatus may include a diffraction phase microscope (DPM), as described with reference to FIGS. 5 and 6.

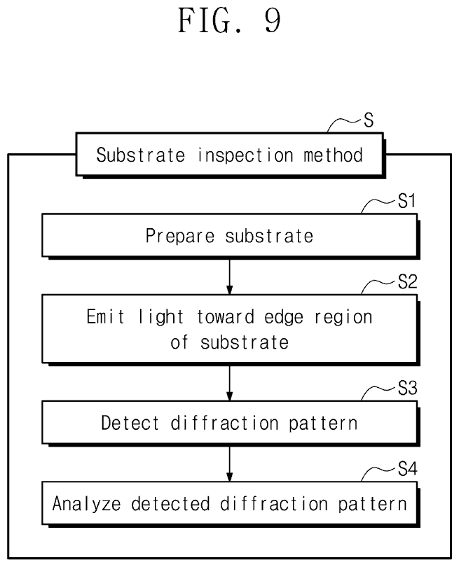

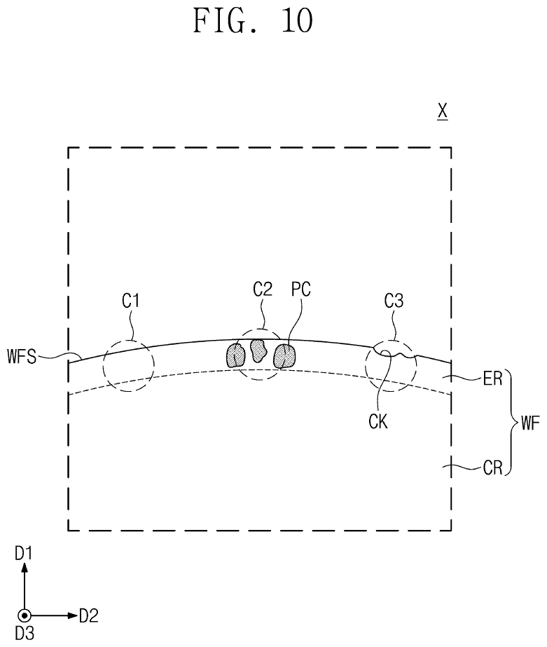

FIG. 9 is a flow chart illustrating a substrate inspection method according to an embodiment of the present disclosure. FIGS. 10 to 14 are diagrams illustrating a substrate inspection method according to an embodiment of the present disclosure. FIG. 10 is an enlarged plan view illustrating the portion X of FIG. 1, and FIGS. 11, 12, and 13 are graphs showing a state of a substrate according to an embodiment of the present disclosure.

Referring to FIG. 9, a substrate inspection method S may be provided. The substrate inspection method S may be used to inspect a substrate using the substrate inspection apparatus 10 or the substrate processing system 1 described with reference to FIGS. 1 to 8. The substrate inspection method S may include preparing a substrate (operation S1), emitting light toward an edge region of a substrate (operation S2), detecting a diffraction pattern (operation S3), and analyzing the detected diffraction pattern (operation S4).

Referring to FIGS. 1, 2, and 9, the preparing of the substrate (operation S1) may include disposing the substrate WF on the supporting portion SP of the substrate inspection apparatus 10 and rotating the substrate WF using the supporting portion SP. More specifically, the substrate WF may be transferred to a region on the supporting portion SP using a robot arm or the like. The substrate WF may be fastened to the supporting portion SP by a vacuum pressure. The substrate WF may be rotated in a clockwise or counter-clockwise direction by the supporting portion SP.

The emitting of the light toward the edge region of the substrate (operation S2) may include emitting the first to fourth lights L1, L2, L3, and L4 toward the edge region ER of the substrate WF. More specifically, the first to fourth light generating portions LS1, LS2, LS3, and LS4 may emit the first to fourth lights L1, L2, L3, and L4 toward the edge region ER of the substrate WF. For example, the first to fourth lights L1, L2, L3, and L4 may be emitted in the tangential direction (e.g., along a virtual tangential line) of the substrate WF. The first light L1 may pass by the edge region ER of the substrate WF at the first edge point EP1. The second light L2 may pass by the edge region ER of the substrate WF at the second edge point EP2. The third light L3 may pass by the edge region ER of the substrate WF at the third edge point EP3. The fourth light L4 may pass by the edge region ER of the substrate WF at the fourth edge point EP4.

In addition, the emitting of the light toward the edge region of the substrate (in S2) may include generating a diffraction light. The diffraction light may be generated by the light passing by the edge region of the substrate, as described with reference to FIG. 3. In addition, a diffraction pattern by the diffraction light may occur. For example, first to fourth diffraction lights may be generated by the first to fourth lights L1, L2, L3, and L4 passing by the edge region ER of the substrate WF, and first to fourth diffraction patterns may be produced by the first to fourth diffraction lights.

Referring to FIGS. 10 and 11, a first portion C1 of the edge region ER of the substrate WF may not have a defect issue (e.g., a contamination particle PC and a crack CK). For example, the first portion C1 may be a portion of the edge region ER of the substrate WF that is in a normal state. As the substrate WF is rotated, the first portion C1 may pass by the first to fourth edge points EP1, EP2, EP3, and EP4 of FIG. 1. The first diffraction pattern DP1 of the first light L1 about the first portion C1 may be detected at the first edge point EP1, as described with reference to FIG. 3. Similarly, a second diffraction pattern DP2 of the second light L2 about the first portion C1 may be detected at the second edge point EP2, a third diffraction pattern DP3 of the third light L3 about the first portion C1 may be detected at the third edge point EP3, and a fourth diffraction pattern DP4 of the fourth light L4 about the first portion C1 may be detected at the fourth edge point EP4. In other words, the detecting of the diffraction pattern (operation S3) may include detecting the first to fourth diffraction patterns DP1, DP2, DP3, and DP4 of the first to fourth lights L1, L2, L3, and L4 having different wavelengths. The detecting of the first to fourth diffraction patterns DP1, DP2, DP3, and DP4 may be performed by the first to fourth detection portions DE1, DE2, DE3, and DE4.

Each of the first to fourth diffraction patterns DP1, DP2, DP3, and DP4 may have a peak at which the intensity of light is the highest. For example, the first diffraction pattern DP1 may have the first peak P1 at a first time T1. The second diffraction pattern DP2 may have the second peak P2 at a second time T2. The third diffraction pattern DP3 may have the third peak P3 at a third time T3. The fourth diffraction pattern DP4 may have the fourth peak P4 at a fourth time T4.

The analyzing of the detected diffraction pattern (operation S4) may include aligning the first to fourth peaks P1, P2, P3, and P4 of the first to fourth diffraction patterns DP1, DP2, DP3, and DP4 and comparing the intensities of the first to fourth peaks P1, P2, P3, and P4. The analyzing of the detected diffraction pattern (operation S4) may be performed by the analyzing unit CTR of FIG. 1. For example, the first to fourth diffraction patterns DP1, DP2, DP3, and DP4 may be aligned based on peaks. Accordingly, the first to fourth peaks P1, P2, P3, and P4 may be placed at the same time based on the synchronized starting time. About the first portion C1, the intensities of the peaks may decrease from the first peak P1 to the fourth peak P4. In other words, the second peak P2 may be smaller than the first peak P1, the third peak P3 may be smaller than the second peak P2, and the fourth peak P4 may be smaller than the third peak P3.

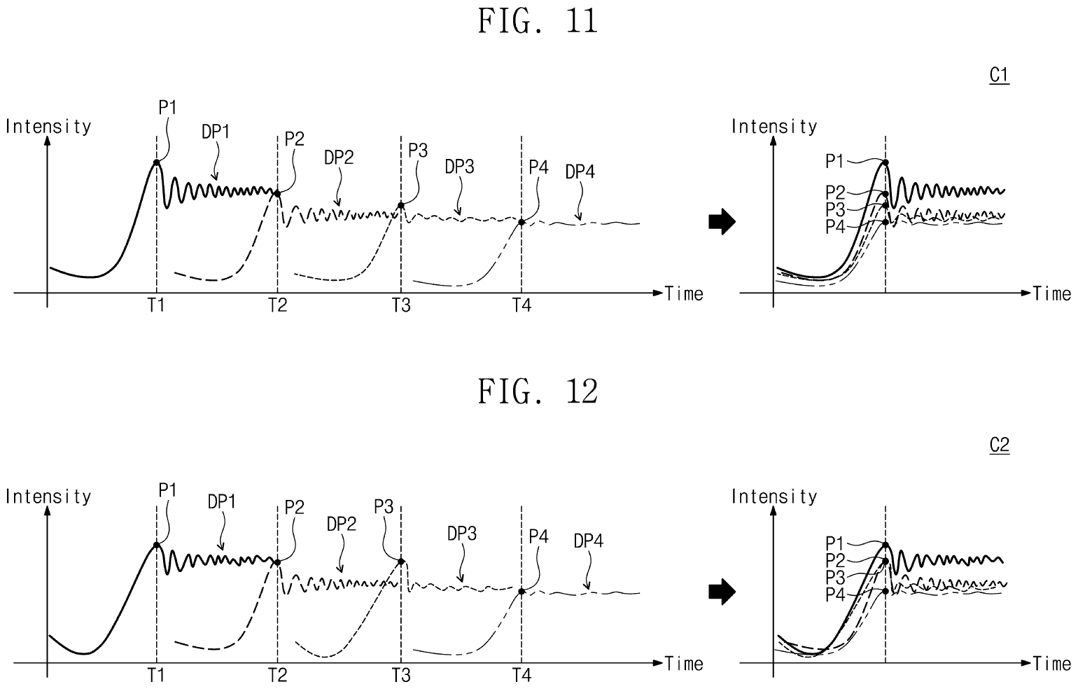

Referring to FIGS. 10 and 12, a second portion C2 of the edge region ER of the substrate WF may have a defect. For example, the second portion C2 may be a portion of the edge region ER of the substrate WF where the contamination particle PC is present. As the substrate WF is rotated, the second portion C2 may pass by the first to fourth edge points EP1, EP2, EP3, and EP4. As described with reference to FIG. 3, the first diffraction pattern DP1 of the first light L1 about the second portion C2 may be detected at the first edge point EP1, the second diffraction pattern DP2 of the second light L2 about the second portion C2 may be detected at the second edge point EP2, the third diffraction pattern DP3 of the third light L3 about the second portion C2 may be detected at the third edge point EP3, and the fourth diffraction pattern DP4 of the fourth light L4 about the second portion C2 may be detected at the fourth edge point EP4. Similar to the first portion C1, the first to fourth diffraction patterns DP1, DP2, DP3, and DP4 may have the first to fourth peaks P1, P2, P3, and P4, respectively.

To analyze the detected diffraction pattern, the first to fourth peaks P1, P2, P3, and P4 of the first to fourth diffraction patterns DP1, DP2, DP3, and DP4 may be placed at the same time based on the synchronized starting time. About the second portion C2, the first peak P1 may be the highest, and the fourth peak P4 may be the lowest. However, the second and third peaks P2 and P3 of the second portion C2 may be substantially equal to each other.

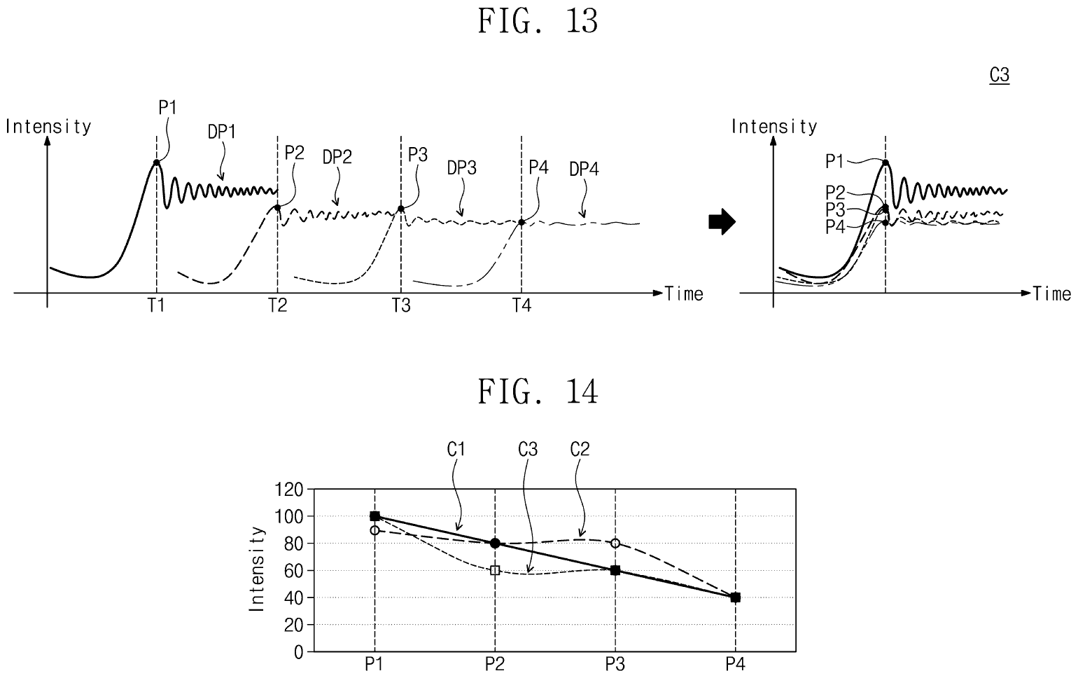

Referring to FIGS. 10 and 13, a third portion C3 of the edge region ER of the substrate WF may have a defect issue. For example, the third portion C3 may be the edge region ER of the substrate WF, in which the crack CK is present. Similar to the first portion C1 and the second portion C2, the third portion C3 may pass by the first to fourth edge points EP1, EP2, EP3, and EP4 of FIG. 1. The first to fourth diffraction patterns DP1, DP2, DP3, and DP4 of the first to fourth lights L1, L2, L3, and L4 about the third portion C3 may be detected at the first to fourth edge points EP1, EP2, EP3, and EP4, respectively. In addition, the first to fourth diffraction patterns DP1, DP2, DP3, and DP4 of the third portion C3 may have the first to fourth peaks P1, P2, P3, and P4, respectively.

To analyze the detected diffraction pattern, the first to fourth diffraction patterns DP1, DP2, DP3, and DP4 may be aligned based on peaks. For example, the first to fourth peaks P1, P2, P3, and P4 of the first to fourth diffraction patterns DP1, DP2, DP3, and DP4 may be located at the same time based on the synchronized reference time. About the third portion C3, the first peak P1 may be the highest, and the fourth peak P4 may be the lowest. Similar to the second portion C2, the second and third peaks P2 and P3 of the third portion C3 may be substantially equal to each other. However, the second peak P2 and the third peak P3 of the third portion C3 may be smaller than the second peak P2 and the third peak P3 of the second portion C2.

Referring to FIGS. 9 and 14, a graph showing the first to fourth peaks P1, P2, P3, and P4 about the first to third portions C1, C2, and C3 of the edge region ER of the substrate WF may be provided. The analyzing of the detected diffraction pattern (operation S4) may further include comparing the first to fourth peaks P1, P2, P3, and P4 about the first to third portions C1, C2, and C3 of the edge region ER of the substrate WF. About the first portion C1, the intensity may decrease at a constant slope from the first peak P1 to the fourth peak P4. About the second portion C2 and the portion C3, the intensity may decrease from the first peak P1 to the fourth peak P4 at a varying slope. For example, a line representing the first to fourth peaks P1, P2, P3, and P4 about the first portion C1 may be linear. Lines representing the first to fourth peaks P1, P2, P3, and P4 about the second portion C2 and the third portion C3 may be nonlinear. In addition, the line representing first to fourth peaks P1, P2, P3, and P4 about the second portion C2, may be different from the line representing the first to fourth peaks P1, P2, P3, and P4 about the third portion C3. That is, the shape of the line representing the first to fourth peaks P1, P2, P3, and P4 may vary depending on the type of defect.

In the substrate inspection method S according to an embodiment of the present disclosure, by analyzing the peaks of the diffraction patterns using the diffraction patterns having different wavelengths, it may be possible to examine whether there is a defect on the edge region ER of the substrate WF and to determine the type of the defect. In the case where a line passing through each of the peaks of the diffraction patterns is a linear line, the edge region ER of the substrate WF may not have a defect issue or may be in a normal state. In the case where the line passing through each of the peaks of the diffraction patterns is a non-linear line, the edge region ER of the substrate WF may have a defect issue and may be in an abnormal state.

According to an embodiment of the present disclosure, a substrate inspection apparatus may include a plurality of light generating portions emitting light having different wavelengths. In the substrate inspection apparatus, a diffraction pattern of the light may be used to inspect an edge region of a substrate. Thus, it may be possible to easily detect various types of defects on the edge region of the substrate. Accordingly, the accuracy of the substrate inspection apparatus may be improved.

In a substrate inspection method according to an embodiment of the present disclosure, by analyzing peaks of diffraction patterns on different wavelengths, it may be possible to examine whether there is a defect on the edge region of the substrate and to determine the type of the defect.

While non-limiting example embodiments of the present disclosure have been particularly shown and described, it will be understood by one of ordinary skill in the art that variations in form and detail may be made therein without departing from the spirit and scope of the present disclosure.

What is claimed is:

1. A substrate inspection apparatus, comprising:
a plurality of inspection units, each of the plurality of inspection units comprising a light generator and a detector;
a supporter configured to support and rotate a substrate; and
an analyzer connected to the detector of each of the plurality of inspection units and configured to analyze an input obtained from the detector,
wherein, in a plan view, the substrate comprises a center region and an edge region enclosing the center region,
wherein the light generator of each of the plurality of inspection units is configured to emit light toward the edge region of the substrate,
wherein the detector of each of the plurality of inspection units is configured to detect the light that is emitted towards the edge region of the substrate, and
wherein each of the plurality of inspection units extends parallel to a top surface of the substrate.

2. The substrate inspection apparatus of claim 1, wherein the plurality of inspection units are two-dimensionally arranged with respect to each other.

3. The substrate inspection apparatus of claim 1, wherein the light generator of each of the plurality of inspection units is configured to emit light of a respective, different wavelength.

4. The substrate inspection apparatus of claim 1, wherein the light generator of each of the plurality of inspection units is configured to, in the plan view, emit the light along a virtual tangential line of the substrate.

5. The substrate inspection apparatus of claim 1, wherein the analyzer is connected to the detector of each of the plurality of inspection units such as to be configured to receive an electrical signal from the detector of each of the plurality of inspection units.

6. A substrate inspection method, comprising:
preparing a substrate including a center region and an edge region enclosing the center region;
emitting at least one light toward the edge region of the substrate;
detecting at least one diffraction pattern based on the at least one light that is emitted toward the edge region of the substrate; and
analyzing the at least one diffraction pattern that is detected,
wherein the emitting the at least one light comprises generating at least one diffraction light, and
wherein the at least one diffraction pattern is produced by the at least one diffraction light.

7. The substrate inspection method of claim 6, wherein the emitting the at least one light comprises emitting the at least one light in a direction parallel to a top surface of the substrate, along a virtual tangential line of the substrate.

8. The substrate inspection method of claim 6, wherein the preparing the substrate comprises rotating the substrate.

9. The substrate inspection method of claim 6, wherein the at least one light propagates as a plane wave, and the at least one diffraction light propagates as a spherical wave.

10. The substrate inspection method of claim 6, wherein the emitting the at least one light comprises emitting a first light, a second light, a third light, and a fourth light towards the edge region of the substrate.

11. The substrate inspection method of claim 10, wherein the first light, the second light, the third light, and the fourth light have different wavelengths from each other.

12. The substrate inspection method of claim 10, wherein the emitting the at least one light further comprises emitting each of the first light, the second light, the third light, and the fourth light in a direction parallel to a top surface of the substrate, along a virtual tangential line of the substrate.

13. The substrate inspection method of claim 10, wherein the generating the at least one diffraction light comprises generating a first diffraction light, a second diffraction light, a third diffraction light, and a fourth diffraction light, and
wherein the at least one diffraction pattern comprises a first diffraction pattern, a second diffraction pattern, a third diffraction pattern, and a fourth diffraction pattern produced by the first diffraction light, the second diffraction light, the third diffraction light, and the fourth diffraction light, respectively.

14. The substrate inspection method of claim 13, wherein the first diffraction pattern has a first peak,
the second diffraction pattern has a second peak,
the third diffraction pattern has a third peak, and
the fourth diffraction pattern has a fourth peak.

15. The substrate inspection method of claim 14, wherein the analyzing the at least one diffraction pattern comprises evaluating the edge region of the substrate as normal based on a line passing through each of the first peak, the second peak, the third peak, and the fourth peak being a linear line.

16. The substrate inspection method of claim 14, wherein the analyzing the at least one diffraction pattern comprises evaluating the edge region of the substrate as abnormal based on a line passing through each of the first peak, the second peak, the third peak, and the fourth peak being a non-linear line.

17. A substrate processing system, comprising:
an interface module comprising an aligner that is configured to align a substrate; and
a substrate processor connected to the interface module,
wherein the substrate comprises a center region and an edge region enclosing the center region,
wherein the aligner comprises:
a supporter configured to rotate the substrate;
an alignment detector configured to detect a notch of the substrate; and
a substrate inspector configured to inspect the edge region of the substrate, and
wherein the substrate inspector is configured to detect a defect on the edge region based on at least one diffraction pattern.

18. The substrate processing system of claim 17, wherein the substrate inspector comprises a light generator and a detector,
wherein the light generator is configured to emit light in a tangential direction of the substrate, and
wherein the detector is configured to detect the light that is emitted.

19. The substrate processing system of claim 17, wherein the substrate inspector comprises a plurality of light generators and a plurality of detectors,
wherein each of the plurality of light generators is configured to emit light with a respective, different wavelength, and
wherein the plurality of detectors are configured to detect the light that is emitted.

20. The substrate processing system of claim 17, wherein the substrate inspector comprises:
a light generator configured to emit light;
a beam splitter configured to split the light; and
a plurality of detectors configured to detect the light.
